(19) United States
(12) Patent Application Publication
(10) Pub. No.: US 2013/0103189 A1
(43) Pub. Date: Apr. 25, 2013

(54) MINI-BAR

(71) Applicant: Giovanni Aulisio, Santa Lucia di Fonte Nuova (IT)

(72) Inventor: Giovanni Aulisio, Santa Lucia di Fonte Nuova (IT)

(21) Appl. No.: 13/655,476

(22) Filed: Oct. 19, 2012

(30) Foreign Application Priority Data
Oct. 19, 2011 (IT) RM2011U000162

(51) Int. Cl. G06F 17/00

(52) U.S. Cl. 700/236; 700/232

(57) ABSTRACT

Mini-bars are provided which have a containment body defining a refrigerated inner housing space for housing a plurality of products, the inner housing space being a space having controlled access communicating with a lower space, the inner space also having a product falling plane. Such mini-bars also may have electronic or electromechanical selection devices, a plurality of actuators, and an electronic control and management unit to track and record usage for both billing and refilling purposes.

### CROSS REFERENCE TO RELATED APPLICATION

This application claims priority to and benefit of Italian Utility Model Patent Application No. RM2011U000162 filed Oct. 19, 2011, the contents of which are incorporated by reference in their entirety.

### FIELD OF THE INVENTION

The present disclosure relates to dispensing devices for food and beverages.

### BACKGROUND OF THE INVENTION

Hotels and similar establishments are well-known for having small containment and refrigerating devices, commonly called mini-bars, for containing beverages, for example, those contained in bottles or cans, and food products generally taken and consumed by the guests of the hotel while staying inside their room. The external dimensions of mini-bars are generally standardized.

Typically, when a guest leaves his/her room to checkout, a reception worker asks the guest whether or not food/beverages have been taken from the mini-bar and consequently charges a sum corresponding to the items taken. Such sum is thus greatly dependent upon the correctness and honesty of the guest in communicating/declaring the actual items taken. It is for this reason that, the management of sales through mini-bar leads to heavy losses. For example, it is estimated that on average around 20% of items taken are not declared at checkout. For various reasons, attempts to recover charges undeclared items are not carried out (for example, so as to avoid losing clients or because such attempts themselves can be costly, or the guests are located abroad).

In addition there are problems in managing mini-bars, for example, problems related to refilling and/or the replacement of expired products, since these operations are related to knowledge of the items actually taken. For example, in refilling operations it is necessary to thoroughly check all of the mini-bars of a hotel daily, or at least of the rooms which have been recently booked or according to the hotel records will be occupied in the near future. This obviously leads to considerable management costs which further reduce the profit margin relative to the sales of products.

In order to overcome the aforementioned drawbacks, mini-bar devices have been developed and proposed, which thanks to optical, magnetic or pressure sensors are capable of instantaneously detecting when a product is taken, in particular the removal or the lifting of a product from its seat, and of communicating it in real time to a centralized monitoring unit for automatically charging on checkout. The aforementioned devices of the prior art however, have proven over time to have a deterrent effect in terms of consumption, indeed since the simple lifting of the product from its seat can be charged even if the product is not consumed and is placed back inside the mini-bar. This can happen for example when a guest simply desires to touch the product, for example to evaluate the temperature, and/or when he or she wants to visually inspect one or more products up close, prior to deciding which item to take or whether to take an item at all.

### SUMMARY OF THE INVENTION

In view of the aforementioned limitations of currently available mini-bars, there is a great need to provide mini-bars which make it possible to keep count of and monitor the actual items taken but in a manner that is both convenient and effective. Such goals are achieved with mini-bars as described herein.

The features and benefits of the present invention are provided in the following detailed description of particular embodiments thereof given as an example and, therefore, being in no way limiting, with reference to the attached drawings briefly discussed below.

### BRIEF DESCRIPTION OF THE FIGURES

FIG. 1 provides a plan view of a frontal elevation of an embodiment of a mini-bar according to the present invention.

FIG. 2 is a three-dimensional view of the mini-bar of FIG. 1.

FIG. 3 is a plan side section view of the mini-bar of FIG. 1.

FIG. 4 is a front plan view of a console which may be associated with a mini-bar according to the present invention.

### DETAILED DESCRIPTION

In the figures, same or similar elements are indicated with the same reference numerals.

With reference to the attached figures, mini-bars according to embodiments of the present invention are indicated in their entirety with reference numeral 1. The mini-bar 1 is a vending machine of products, such as packaged food products or beverages in bottles or cans, and comprises a containment body 2, refrigerated inside, having a generally box-like shape. The containment body 2 may include insulated walls which provide an insulated inner housing space 6 for products such as packaged foods 20 and beverages 21 in bottles or cans, to be dispensed. In certain embodiments, the aforementioned walls of the containment body 2 may be insulated through insulating panels made from polystyrene (for example, ISOSTIR of 10 mm or similar).

The inner housing space 6 is a refrigerated space and for such a purpose the mini-bar 1 comprises a compressor, a static evaporator (not shown in the figures) and a refrigerating plate 25 that are housed inside the containment body 2. This type of refrigerating device advantageously has low noise due to the forced circulation of air inside the containment space 2.

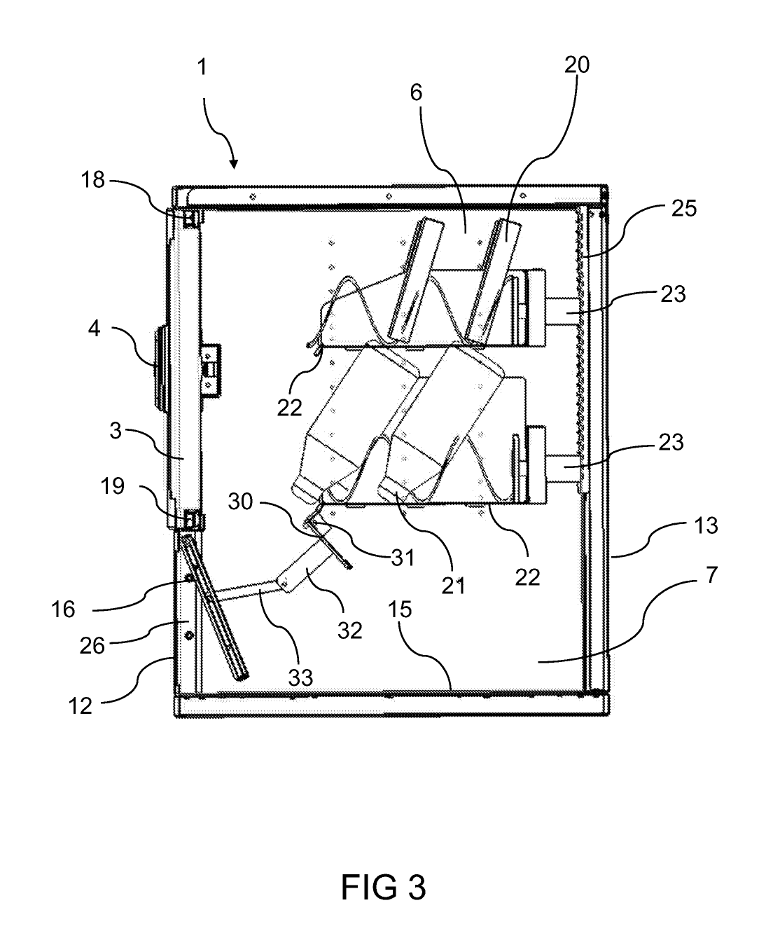

The containment body 2 also includes a lower space 7 for taking products, arranged below the space for housing the products 6 and may include a product falling plane 15. The lower space 7 for taking products communicates with the space for housing the products 6. In certain embodiments such spaces 6,7 may be physically separate from one another, for example, by use of a shelf 22 (e.g. lower shelf 22 in FIG. 3). In certain embodiments, the product falling plane 15 may be an inclined plane so as to facilitate a natural movement of the dispensed products towards the front wall 12 of the containment body 2.

The containment body 2 of the mini-bar 1 typically has relatively small dimensions, for example, a height of around 550 mm, a width of around 400 mm and a depth of around 450 mm.

The containment body 2 includes a front door 3 to provide access to the inner housing space 6. A locking system 4 may be associated with the front door 3. Such locking systems may include a mechanical key lock, provided in order to allow only service staff, equipped with a special key, to open the front door 3. For this reason, the inner housing space 6 may be defined as a space having controlled access. With reference to FIG. 3, in certain embodiments, the front door 3 may be hinged to the front wall 3 through two pins 18, 19 of which at least one, for example the lower one 19, may be retractable so as to allow the easy removal of the front door 3 from the front wall 12 of the containment body 2, (when the front door 3 is not locked by the locking system 4 and is open).

In certain embodiments, the front door 3 houses a heat double glazing system 5 which allows for visual inspection of the housing space 6 from outside and thus the products available for distribution.

The mini-bar 1 includes a collection opening 26 that allows access to the lower product fall space 15 from outside enabling a user to manually take a product that has been selected and dispensed. Such a collection opening 26 may be removably closed off by one collection flap 16. With reference to FIG. 3, in certain embodiments, the collection flap 16 may be a tilting flap which has an upper side which is rotatably hinged to the front wall 12 below the door 3. Such a collection flap 16 thus may rotate around a rotation axis that is generally horizontal.

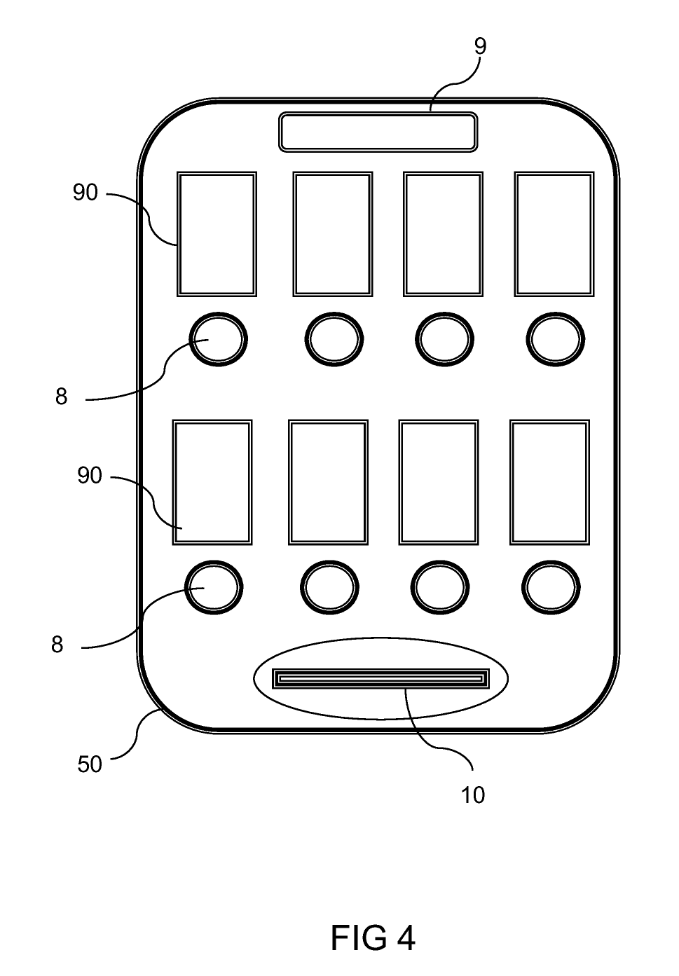

The mini-bar 1 may further comprise an electronic or electromechanical selection device 8 of products to be dispensed. As shown in FIG. 4 the selection device 8 may be in the form of a keypad, for example a numeric keypad, through which a guest can enter a code (for example a number), or in general selection information, associated with a product which then can be dispensed. Alternatively, the selection device 8 may be, for example, a touch-screen.

The selection device 8 also may provide information to the staff in charge of carrying out the refilling operations, for example to introduce through suitable codes information about the products (for example quantity and/or type and/or expiration date). The mini-bar 1 also may include an electronic control and management unit, operatively connected to the selection device 8 so as to receive selection data introduced by the user through the selection device 8 which thus controls the dispensing of the products.

The mini-bar 1 also may include a display 9. Such a display 9, of course, is not necessary when the selection device 8 includes a touch-screen.

The mini-bar 1 also may include a reading device 10 or reading/writing device 10 of an external storage unit which is removably coupled to the reading device 10. Such an external storage unit may be, for example, a smart card with chip or a memory stick. The reading device 10 may be in this case a reader (possibly with the option of writing) of a smart card or memory stick. Such a reading device 10 makes it possible to implement a system for enabling dispensing. For example, such a system provides each guest (or a group of guests in the same room) is allocated with a respective storage unit during check-in, along with a smart-card or a memory stick, necessary for taking products from the mini-bar 1. This limits potential protests by guests on the identity of the person taking a product. In addition, in certain embodiments information on the age of the guests may be stored during check-in, so that the mini-bar 1 can carry out a verification to prevent users of some age groups from taking products which are forbidden to be sold to such age groups (for example, so as to prevent minors from purchasing alcohol).

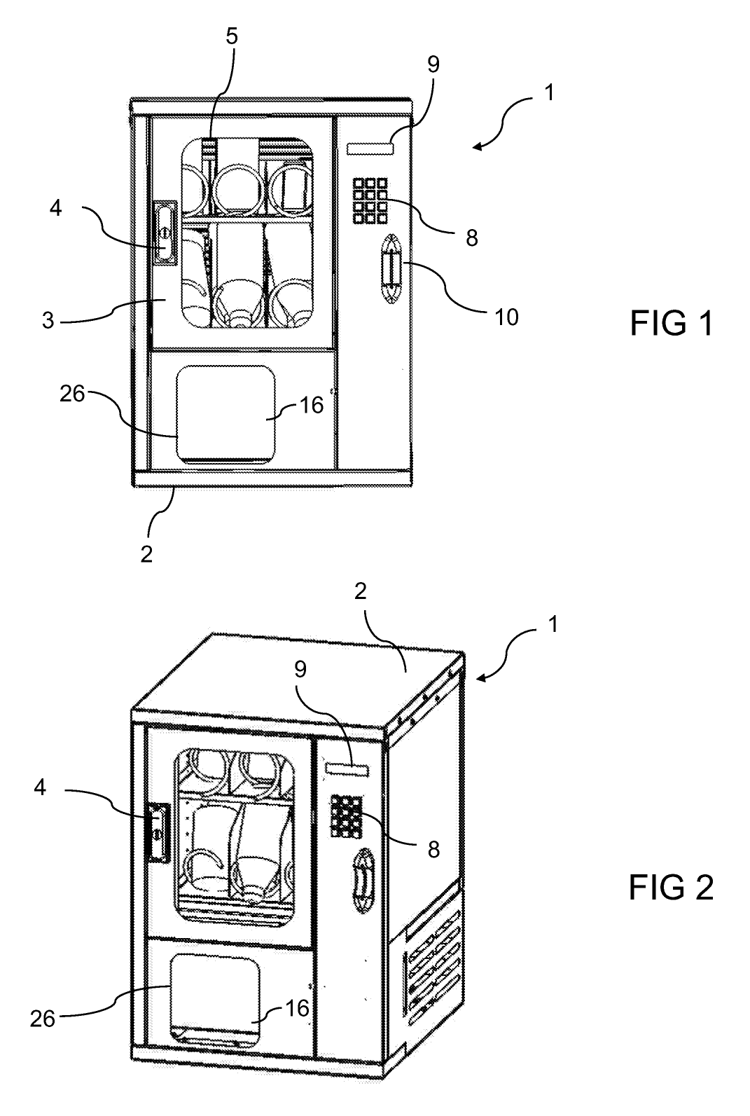

As shown in the attached FIGS. 1-3, the selection device 8 in certain embodiments may be fixedly coupled with the containment body 2, being for example provided on the front wall 12 of the containment body 2 beside the front door 3. With reference to FIG. 4, in certain embodiments, the selection device 8 (which in the example of FIG. 4 comprises a plurality of buttons 8) may be built into an external unit 50, which is part of the mini-bar 1 and which is operatively connected or connectable to the electronic control and management unit. The external unit 50 is typically outside of the containment body 2, and is not stably fixed thereto. It may be operatively connected, for example, through an electric cable or by wireless connection, to the containment body 2. In such embodiments the selection device 8 is outside and mobile with respect to said containment body 2. For example, the external unit 50 of FIG. 4 may be an external console 50.

In certain embodiments the external unit 50 may be a stand-alone unit which is operatively connected or connectable to the electronic control and management unit.

Such an external unit 50, during normal operation, is typically housed outside of containment furniture of the mini-bar 1, for example, fixed to a bracket or resting, free or anchored, to said piece of furnishing. When the mini-bar 1 also comprises the display 9 and the memory reader 10 it is advantageous, as shown in FIG. 4, that these are provided in the external unit 50, so as to centralize the input/output interfaces in a single unit. In such embodiments an external unit 50 can advantageously include, as an alternative to the display 9 and to the selection device 8, a touch-screen on which icons identifying available products can be shown (e.g. only the products which are actually available).

As shown in FIG. 4, in further embodiments, as an alternative to the touch-screen and as an alternative or in combination with the display 9, a plurality of back-lighted label holders 90 associated with the buttons 8 and suitable for supporting labels carrying images of the products which can be dispensed can be provided in the external unit 50. In a further embodiment the label holders may be integrated inside the buttons 8, thus allowing for dimensions which are relatively greater.

It should be observed that the provision of an external input unit 50 or input/output unit 50 provides numerous advantages in terms of convenience and efficiency of use. First, when the mini-bar 1 is resting on the floor, the user does not have to bend over to insert the external storage unit into the reader 10, so as to introduce the code of the product to be taken and for viewing the display 9. In addition, an external unit 50 advantageously allows for the elimination of components associated with the front wall of the containment body 2 which allows for an increase in the lateral dimension (i.e. the width) of the double glazing system and possibly also of the door 3. This allows the user to more easily view the available products which in FIG. 1 (fourth column from the left) are arranged behind the input device 8, the display 9 and the reader 10 and that in any case would otherwise be at least partially hidden.

In addition, since mini-bars usually are hidden from sight in special containment furniture with a door or hinge, the external unit 50 if housed outside such containment furniture, showing the presence of a mini-bar 1 housed inside the containment furniture, could encourage guests to use the mini bar 1 at a greater frequency.

As shown in FIG. 3, the mini-bar 1 may include a plurality of actuators 23 which can be used to control the fall of selected products on the product falling plane 15. Such actuators 23 may be operatively connected to the electronic control and management unit. The management unit may control said actuators based upon selection data inserted by the user through the selection device 8. In particular, following the input of selection data using the selection device 8, the electronic control and management unit may command in a selective manner an actuator 23 of the plurality of actuators corresponding to the product which a user intends to take.

The mini-bar 1 may include a plurality of shelves for housing the products 22 that is suitable for supporting the products housed inside the housing space 6. Such shelves for housing the products 22 are typically fixed to the inner walls of the containment body 2. The mini-bar 1 may include, for example, two shelves for housing the products 22. Each shelf 22 may have, for example, four columns for housing the products. Each housing column may house, for example, at least two products.

In certain embodiments, the actuators 23 may be electromechanical spiral actuators which can be commanded to transport the products from their respective shelves 22 until the point at which they cause the products to fall on to the falling plane 15.

As shown in FIG. 3, in certain embodiments there is a significant amount of space 7 below the shelves 22 providing easy access to the products selected. Such space can be accessed through the collection opening 26, and can be used as a refrigerated container in which, for example, a hotel guest may freely replace products which he or she desires to keep refrigerated, for example products dispensed and taken from the mini-bar 1 and only partially consumed.

In certain embodiments, the mini-bar 1 may include a mobile protective barrier 30 provided so as to prevent theft of products 20, 21 from the space for housing the products 6. Such mobile protective barrier 30 may include a tilting plate which may be rotatably hinged, through a shaft 31, at the lowest of the plurality of housing shelves 22. The mini-bar 1 may include a lever mechanism that is adapted for operatively coupling the mobile protective barrier 30 with the door 16, so that an opening of the door causes an upward rotation of the barrier 30. As shown in FIG. 3, such a lever mechanism may include a pair of arms 32, 33, rotatably hinged to one another interposed between the barrier 30 and the door 16. One of such arms, in particular arm 32, may be stably fixed to the barrier 30 whereas the other arm, in particular arm 33, may have an end portion that is rotatably hinged to the door 16 and an opposite end portion that is rotatably hinged to the arm 32.

In certain embodiments, the mini-bar 1 may be equipped with a network interface, wireless or cabled, for example connected to the electronic management and control unit, provided for communicating in real time to a remote control server (for example at reception) requests for dispensing and/or information on successful dispensing. In particular, this information may be correlated to the actual dispensing of a specific product (or of a product from a specific position). Moreover, the server may be programmed so as to keep track of the content of the mini-bar 1, whether locally or remotely (for example, during refilling through the same mini-bar 1) and consequently enable the dispensing (i.e. only if a product required by a user through the mini-bar 1 is actually available). A single server may be programmed so as to manage a network of mini-bars, for example, all the mini-bars of a hotel.

Moreover, the remote server may be advantageously programmed to enable dispensing following verifying of the data relative to the external storage unit which can be read by the reading unit 10 (for example, after having checked that the storage unit corresponds to the room in which the mini-bar is housed and/or after having checked data relative to the age of the user, when there are restrictions on the dispensing of certain products based on age).

Also the same updating of the refilling data may occur through the aforementioned network interface. For example, each worker may be equipped with a “worker key card” or a similar device. When such a card is inserted into the reader 10, the mini-bar 1 may shift to an operative mode in which the worker can insert, for example, through the selection device 8, data relating to the products needed for refilling the mini-bar. Such data can be sent to a remote server.

The mini-bar 1 also may be designed and programmed so that when a network connection is not available, for example, if it is temporarily interrupted or because the installation room is not equipped with one, all the aforementioned operations of communicating between the mini-bar 1 and the remote server can be carried out offline, through the external storage unit, which thus enables the dispensing and storage of the data of successful dispensing so that at checkout there is an accurate record of the use of the min-bar. The same control may be used to update the server on the need to refill a specific mini-bar 1. The same may apply to the external storage unit used by the refilling worker which can be used as an off-line means for transferring data of successful refilling from the mini-bar 1 to the remote server.

When there is a functioning network connection, the external storage unit (i.e. that of the user and/or that of a worker) can be used to carry out all the aforementioned operations in parallel and to allow for a redundancy cross-check to be carried out at the remote server.

Of course, a person skilled in the art, in order to satisfy contingent and specific requirements, may carry out numerous modifications based on the present disclosure. Such modifications are intended to be covered by the scope of protection of the present invention, as defined by the following claims.

1. A mini-bar vending machine device, comprising
a containment body defining a refrigerated inner housing space for housing a plurality of products, the inner housing space being a space having controlled access and being in communication with a lower space for obtaining said products, said lower space comprising a product falling plane,
an electronic or electromechanical selection device adapted for allowing a user to insert selection data associated with a product,
a plurality of actuators to facilitate movement of products onto the product falling plane,
an electronic control and management unit that is operatively connected to the selection device and that is adapted for receiving said selection data so as to control, in a selective manner, an actuator of said plurality of actuators corresponding to the product, and
a collection flap adapted for allowing access to the lower space from outside,
wherein said selection device is external and mobile with respect to said containment body, the mini-bar being provided with an external unit comprising said selection device.

2. The mini-bar of claim 1, further comprising a reading unit adapted to read an external data storage unit.

3. The mini-bar of claim 1, further comprising a display.

4. The mini-bar of claim 1, wherein the selection device comprises a touch-screen.

5. The mini-bar of claim 2, wherein said external unit comprises said reader.

6. The mini-bar of claim 3, wherein said external unit comprises said display.

7. The mini-bar of claim 1, wherein said external unit is an external console, and wherein said selection device comprises a plurality of buttons comprised in said external console.

8. The mini-bar of claim 7, wherein said external console comprises a plurality of label holders, each associated with a respective button of said plurality.

9. The mini-bar of claim 7, wherein said external console comprises a display.

10. The mini-bar of claim 1, comprising a collection opening that is adapted for allowing access to the lower space obtaining said products, so as to allow a user to manually take a product that has been selected and dispensed, the collection opening being removably closed off by a collection flap.

11. The mini-bar of claim 1, comprising a plurality of shelves for housing the products.

12. The mini-bar of claim 11, wherein said shelves comprise a shelf that is relatively lower with respect to the other shelves of said plurality, and wherein the mini-bar comprises a mobile protective barrier provided so as to prevent theft of products from the space for housing the products, the mobile protective barrier comprising a tilting plate that is rotatably hinged to said relatively lower shelf.

13. The mini-bar of claim 11, wherein a substantial part of the lower space projects below the shelves for housing the products for a substantial part of their size with respect to depth.

14. The mini-bar of claim 1, wherein said falling plane is an inclined plane.

15. The mini-bar of claim 1, comprising a network interface, that is wireless or cabled and is capable of communicating in real time to a remote server for controlling dispensing approval requests and/or information of successful dispensing.

16. The mini-bar of claim 2, wherein said reading unit reads, from the external storage unit, data concerning the authorization for the dispensing of products and/or data relative to the need to refill the mini-bar.

17. The mini-bar of claim 16, wherein the reading unit is a reading and writing unit and it is also provided for writing in the external storage unit data of actual dispensing that has occurred and/or data relative to the refilling operations of the mini-bar.

18. The mini-bar of claim 1, wherein the containment body of the mini-bar has a height of about 550 mm, a width of about 400 mm and a depth of about 450 mm.

19. The mini-bar of claim 1, wherein said external unit comprising said selection device is a stand-alone unit.

20. A mini-bar, comprising
a containment body defining a refrigerated inner housing space for housing a plurality of products, the inner housing space being a space having controlled access and being in communication with a lower space, said lower space comprising a product falling plane,
an electronic or electromechanical selection device adapted for allowing a user to insert selection data associated with a product,
a plurality of actuators to facilitate movement of products onto the product falling plane,
an electronic control and management unit that is operatively connected to the selection device and that is adapted for receiving said selection data so as to control, in a selective manner, an actuator of said plurality of actuators corresponding to the product, and
a collection flap adapted for allowing access to the lower space from outside.
